(19) United States
(12) Patent Application Publication
(10) Pub. No.: US 2008/0034149 A1
(43) Pub. Date: Feb. 7, 2008

(54) High capacity USB or 1394 memory device with internal hub

(75) Inventor: Hui-Ying Sheen, Torrance, CA (US)

Correspondence Address: YING CHEN;Chen Yoshimura LLP, 255 S. GRAND AVE., # 215, LOS ANGELES, CA, 90012, US

(73) Assignee: Feringo, Inc.

(21) Appl. No.: 11/498,357

(22) Filed: Aug. 2, 2006

(51) Int. Cl. G06F 12/00; G06F 13/20

(52) U.S. Cl. 711/100; 710/313

(57) ABSTRACT

A high capacity USB or 1394 memory device includes a USB or 1394 port for connecting to an external USB or 1394 port (i.e. the USB or 1394 port of a host device such as a computer), a USB or 1394 hub controller having an upstream end connected to the USB or 1394 port, a plurality of memory controllers each connected to a downstream end of the USB or 1394 hub controller, and a plurality of memory banks each including a plurality of memory elements, each memory bank being connected to and controlled by a memory controller. The memory device additionally includes support circuitry such as a voltage regulator and one or more oscillators. The hub controllers and memory controllers can be programmed to implement a RAID algorithm. The memory device provides increased memory capacity and read/write speed while saving space, power and cost.

### BACKGROUND OF THE INVENTION

1. Field of the Invention

This invention relates to memory devices, and in particular, it relates to USB or 1394 memory devices.

2. Description of the Related Art

USB or 1394 memory devices are non-volatile semiconductor memory devices that can be directly inserted into a USB (universal serial bus) or 1394 (Firewire®) port of computers or other devices. One type of widely used USB memory devices employs flash chips as the underlying memory, and is commonly referred to as USB flash drives. These devices provide large storage capacity and are compact, lightweight, portable, and convenient to use. The capacity of a USB memory device is limited by a number of factors, including the capacity of the memory chips and the number of memory chips that can be included in one memory device.

### SUMMARY OF THE INVENTION

The present invention is directed to a USB or 1394 memory device having a high memory capacity, higher data transfer rate, and flexibility in programming the functionality of device.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a memory device that includes: a universal serial bus (USB) or 1394 (Firewire®) port for connecting to an external USB or 1394 port; a USB or 1394 hub controller having an upstream end connected to the USB or 1394 port; a plurality of memory controllers each connected to a downstream end of the USB or 1394 hub controller; and a plurality of memory banks each including a plurality of memory elements, each memory bank being connected to and controlled by a memory controller. The memory device additionally includes support circuitry such as a voltage regulator and one or more oscillators.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a USB or 1394 memory device according to an embodiment of the present invention.

FIG. 1(a) schematically illustrates a hub controller used in one embodiment of the present invention.

FIG. 2 schematically illustrates two connected USB or 1394 hub devices used in another embodiment of the present invention.

FIG. 3 schematically illustrates a conventional USB or 1394 memory device.

### DETAILED DESCRIPTION OF THE PREFERRED EMBODIMENTS

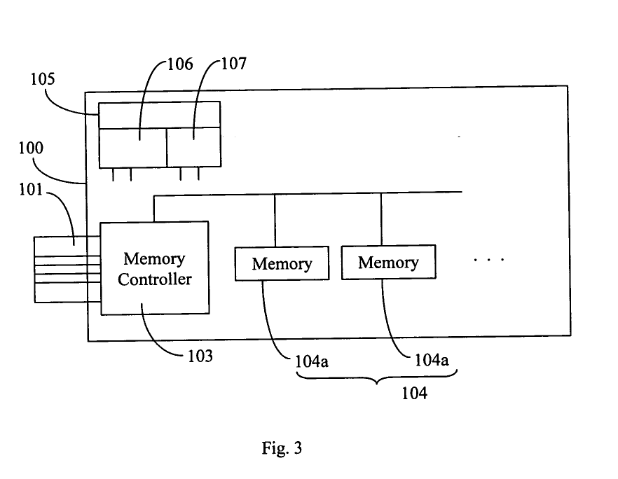

As shown in FIG. 3, a conventional USB or 1394 memory device 100 includes a USB (universal serial bus) port 101, a memory controller 103 connected to the USB or 1394 port, a plurality of memory chips 104 connected to and controlled by the memory controller, and support circuitry 105 which includes various circuits performing support functions for the USB memory device, such as an oscillator for generating a clock signal, a voltage regulator for generating a suitable voltage for the memory chips, etc. The memory controller 103, the memory chips 104 and the support circuitry 105 are mounted on a printed circuit board and enclosed in a casing. The storage capacity of the USB or 1394 memory device 100 is limited by the storage capacity of the memory chips 104 and the number of memory chips that can be controlled by the memory controller 103, the latter being limited by the design of the commercially available memory controller chips, such as the number of pins on a controller chip. One type of commonly available USB or 1394 memory devices use flash chips as the memory chips 104, and the memory controller 103 is sometimes referred to as a flash controller. A typical commercially available flash controller can control up to sixteen flash chips. Therefore, if each flash chip has a 1 GB (gigabyte) memory capacity, for example, then the maximum memory capacity for a USB or 1394 flash memory device would be 16 GB. Custom flash controllers may be made with more pins to control more flash chips, but it would increase the cost, size and power consumption of the overall memory device, and decrease the processing power of the flash controller.

The descriptions below use USB (universal serial bus) and 1394 (Firewire®) ports as examples of data communication ports or channels, but the invention is not limited to such specific communication ports. The invention can be used with other communication ports and standards, either wired or wireless, including communication devices and standards that may be developed in the future. Preferably, such communication ports use one or more pairs of differential data lines.

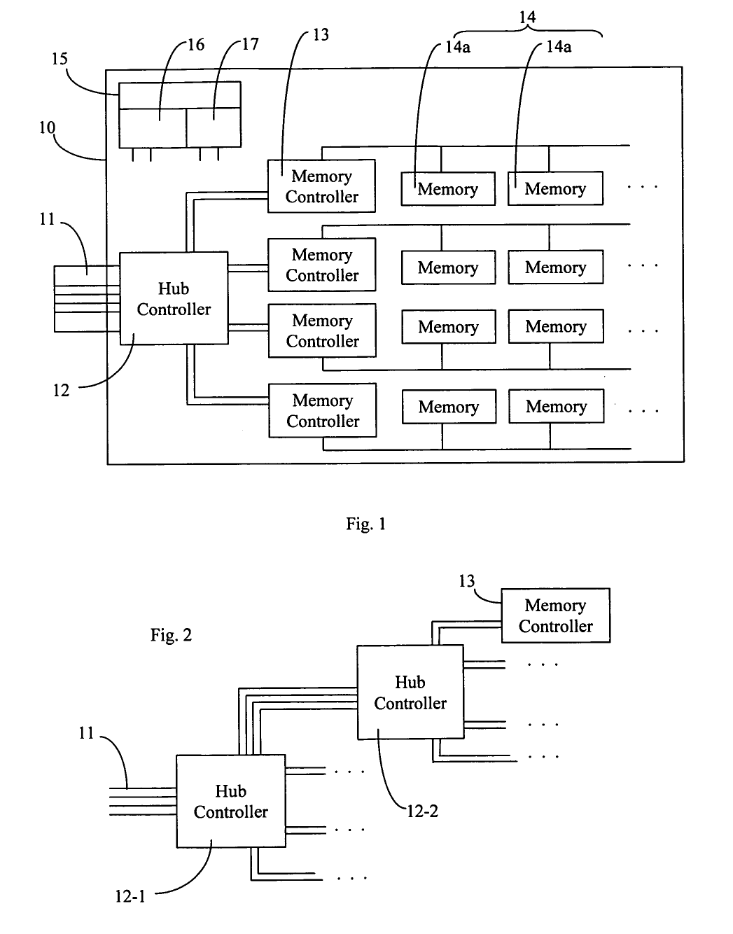

FIG. 1 illustrates a USB or 1394 memory device 10 according to an embodiment of the present invention. The memory device 10 includes a USB or 1394 port 11 for connecting to an external USB or 1394 port (e.g., the USB or 1394 port of a host device such as a computer), a USB or 1394 hub controller 12 having an upstream end connected to the USB or 1394 port 11, a plurality of memory controllers 13 each connected to a downstream end of the hub controller 12, and a plurality of memory banks 14 each including a plurality of memory elements 14a, each memory bank being connected to and controlled by a memory controller 13. The USB or 1394 memory device 10 also includes support circuitry 15 which includes a voltage regulator 16, one or more oscillators 17, and other appropriate support circuits. The USB or 1394 hub controller 12, the memory controller 13, the memory elements 14a and the support circuitry 15 are preferably mounted on one or more printed circuit boards and enclosed in a casing.

The USB or 1394 port 11 has a design that complies with the USB or 1394 standard, respectively. The USB standard requires four lines for each USB port, including a power line (5V), a ground line, and two data lines (D+ and D−); the 1394 standard requires six lines for each 1394 port, including a power line (9V-30V), a ground line, and four data lines (TPA+, TPA−, TPB+, TPB−).

The memory elements 14a may be, for example, semiconductor memory chips such as flash chips, small form factor hard drives, other types of non-volatile memory devices, or a combination thereof, or a combination of non-volatile and volatile memories such as RAM, SRAM, SDRAM, DDR-SDRAM, etc. The memory controllers 13 control the functions of the memory elements such as read and write functions. It communicates data and command with a host device via the USB or 1394 port 11 and the hub controller 12.

A USB or 1394 hub controller is a device that can be connected to one upstream USB or 1394 port and a plurality of downstream USB or 1394 ports. Such hub controllers are commonly used in stand-alone USB or 1394 hub units (devices typically used for connecting an extended number of USB or 1394 devices to a computer that have a limited number of USB or 1394 ports), or used inside peripheral devices. One type of commonly commercially available hub controllers can connect to four downstream USB or 1394 ports. In one preferred embodiment of the present invention (e.g. as shown in FIG. 1), the USB or 1394 hub controller 12 is a commercially available hub controller capable of supporting four downstream ports. The hub controller 12 provides two data lines corresponding to the data lines D+ and D− of the USB port (for a USB application), or four data lines corresponding to the data lines TPA+, TPA−, TPB+, TPB− of the 1394 port (for a 1394 application), to each downstream memory controller 13. Alternatively, the hub controller 12 may be a custom-made controller IC chip and can be made to support a desired number of downstream memory controllers 13. The hub controller may be an intelligent controller with embedded hub functions that can be programmable by a connected computer or preprogrammed by the manufacturer and user to provide special functions such as RAID and security. As another alternative, the hub controller 12 may be combined with one of the memory controllers 13 into one IC chip, i.e., the chip may be a memory controller with an embedded USB or 1394 hub controller function. In such a configuration, the combined hub controller/memory controller chip can directly control one bank of memory elements and can be connected to a plurality of other memory controllers at the downstream end. As yet another alternative, the functions of the hub controller and the plurality of memory controllers can be implemented in one chip.

FIG. 1(a) shows further detail of a hub controller 12 used in one embodiment of the present invention, referred to herein as an “intelligent hub” for convenience. The memory elements 14a shown in FIG. 1 are not shown in FIG. 1(a). The hub controller 12 includes a function controller 12a and a routing matrix 12b. The routing matrix 12b has an embedded hub functionality that generates a plurality (four shown here) of downstream data ports from one upstream data port. The routing matrix 12b is connected to the plurality of memory controllers 13 through downstream ports 12c. Data paths are provided in the routing matrix 12b to route data from the upstream port to one downstream port or to two or more downstream ports simultaneously, as well as to route data from one downstream port to one or more other downstream ports. The routing of data by the routing matrix 12b is controlled by the function controller 12a through a plurality of switches in the routing matrix (not shown). The function controller 12a may also performs various computations such as implementing a RAID algorithm (e.g. RAID 0, 1, 2, 3, 4, 5, etc.). The routing matrix provides increased flexibility in handling data.

The function controller 12a is connected a reset circuit 21, a function hardware strap 22, and/or an non-volatile memory EEPROM (I²C or 3Wire) 23 (the non-volatile memory 23 may also be integrated into the hub controller 12 itself). The function controller 12a may be programmed in several ways. First, the programs (function settings) may be downloaded from a host computer through the upstream USB or 1394 port 11. Second, it may be programmed by the function hardware strap 22 after the reset circuitry 21 actively resets the hub controller 12. Third, the function settings may be read-in by the hub controller 12 from non-volatile memory (e.g. EEPROM) 23 that is either preprogrammed by the manufacturer or re-programmed by user from a host computer through the upstream USB or 1394 port 11. Fourth, the function controller 12a may automatically detects the configuration of the memory controllers 13 attached to the downstream ports 12c. Once the function controller 12a has set its functions by the means mentioned above, the function controller 12a can control the routine matrix 12b to route data to the data paths (downstream ports) 12c to optimize the speed and function for the different functions (e.g. RAID 0, 1, 2, 3, 4, 5, etc.).

The USB or 1394 hub controller 12 is programmed to control the communication between the host device (such as a computer) connected to the port 11 and the memory controllers 13. The hub controller 12 and the memory controllers 13 may be programmed so that each memory bank 14 controlled by a memory controller 13 is a logical device (e.g. corresponds to one drive letter as appears to the host device) or two or more logical devices (e.g. corresponds to two or more drive letters). The programming may be done by a user through a computer or preprogrammed by the manufacturer. Alternatively, the hub controller 12 and the memory controllers 13 may be programmed (by a user or the manufacturer) so that the entire device 10 is one logical device (e.g. corresponds to one drive letter) or two or more logical devices (e.g. corresponds to two or more drive letters). Other combinations may be programmed as desired; for example, a subset of the memory banks may collectively constitute one logical device while each of the remaining memory banks is a logical device. In addition, striping (RAID0) or other RAID (Redundant Array of Independent Disks) algorithms may be implemented on the logical device(s) as described in more detail later. These functionalities of the hub controller 12 and memory controllers 13 may be implemented using software, firmware or hardware.

The USB or 1394 memory device configuration shown in FIG. 1 has many advantages. It offers increased memory capacity while saving space and power. It can be implemented with reduced numbers of components, and as a result, offers lower cost as compared to the conventional approach of providing expanded memory capacity by using a collection of separate, lower capacity USB memory devices connected via a USB hub device. The various advantages of the embodiments of the present invention are further explained below.

A USB port provides a voltage of approximately 5V as required by the USB standard; a 1394 port provides a voltage of approximately 9V-30V as required by the 1394 standard. Since flash chips typically requires power supplies of a lower voltage such as 3V, 2.5V or 1.8V, conventional USB or 1394 memory devices require a voltage regulator (converter) circuit in each memory device to convert the 5V voltage provided by the USB port or the 9V-30V voltage provided by the 1394 port to the appropriate voltage for the flash chips. In a USB or 1394 memory device according to embodiments of the present invention, only one voltage regulator 16 is required to supply power to all of the memory elements 14a. The input of the voltage regulator 16 is connected to the voltage lines of the USB or 1394 port 11 and the output is connected to the memory elements 14a (the connections are not shown in FIG. 1 to avoid over crowding). Most commercially available hub controllers and memory controllers have built-in voltage regulators to supply the appropriate voltages for their internal circuits (e.g. 2.5V or 1.8V for their core logic and 3.3V for interfacing to I/O such as flash chips); but if they do not have built-in voltage regulators, then one or more common voltage regulators can be provided in the memory device 10 to supply the voltages needed by these controllers. As a result, duplication of components is avoided as compared to the conventional approach of using a collection of separate USB or 1394 memory devices, thus saving space and cost. Using fewer voltage regulators also saves power because voltage regulators have a limited efficiency.

The USB or 1394 memory device according to embodiments of the present invention also avoids duplication of components because fewer oscillation circuits are required as compared to the conventional approach of using a collection of separate USB or 1394 memory devices. Each memory device 10 typically requires at most two crystal oscillators 17, one for providing a clock signal to the hub controller 12 (for example, a 30 MHz clock) and one for providing a clock signal to the memory controllers 13 (for example, a 12 MHz clock). In a conventional configuration which uses a collection of separate USB or 1394 memory devices a connected to a USB or 1394 hub device, each memory device has an oscillator circuit, and the USB or 1394 hub device has another oscillation circuit. Thus, the configuration according to embodiments of the present invention reduces the number of oscillator circuits, thereby saving space, power and cost as well as reducing EMI noise. EMI noises tend to reduce the stability of the product as well as interfere with the environment around it.

The USB or 1394 memory device 10 according to embodiments of the present invention can be completely powered by the power supplied from the USB or 1394 port 11 and does not require an external power source. The USB standard requires 500 mA of current to be supplied by an upstream device to a downstream device. When the memory device 10 is inserted into a USB port of a host, the 500 mA current provided from the USB port 11 is normally sufficient to power all the components within the memory device 10, including the hub controller 12, the memory controllers 13, the memory elements 14a and the support circuitry. This makes the USB memory device portable. In a conventional stand-alone USB hub, because the hub is required to provide 500 mA of current to each downstream port (unless the downstream devices are self powered), an external power source is typically required for the hub device, which affects its portability. Similarly, the 1394 standard requires 1500 mA of current to be supplied by an upstream device to a downstream device. When the memory device 10 is inserted into a 1394 port of a host, the 1500 mA current provided from the 1394 port 11 is normally sufficient to power all the components within the memory device 10, including the hub controller 12, the memory controllers 13, the memory elements 14a and the support circuitry. This makes the 1394 memory device portable. In a conventional stand-alone 1394 hub, because the hub is required to provide 1500 mA of current to each downstream port, an external power source is typically required for the hub device, which affects its portability.

As compared to the conventional approach of using a collection of separate USB or 1394 memory devices connected via a USB or 1394 hub device, the USB or 1394 memory device according to embodiments of the present invention also reduces the use of connectors and avoids the disadvantages associated with connectors. For example, for four ports of downstream banks on a standard hub and separated four banks of flash, 4 pairs (4 female and 4 males) of USB or Firewire connectors would be needed in the conventional configuration. There are several disadvantages of using four pairs of connectors. First, the connectors are large in size which reduces the portability of the memory device. Second, it is costly to use four pairs of connectors. Connectors rely on physical contacts of metal tabs inside the connectors, and male and female connectors from different vendors may have different tolerance which may affect the tightness of fit thus causing connectivity problem of signals on the contacts. Also, after thousands of plug in and out, the contact tabs inside the connector and the connectors themselves would also wear out. Embodiments of the present invention eliminate the need for connectors, thereby avoiding the problems of using pairs of connectors mentioned above.

A memory device according to embodiments of the present invention can offer many times (e.g. four times) the memory capacity than today's largest capacity flash drive (16 GB) while maintaining a compact size. A typical commercially available flash drive today is less than 2½ inches long, less than 1 inch wide, and less than ½ inch thick. A flash drive offering a 64 GB capacity can be made within approximately the same size as above or smaller. In one particular example, a 64 GB flash drive has a size of 2.96 inches long, 1.02 inches wide and 0.41 inches thick.

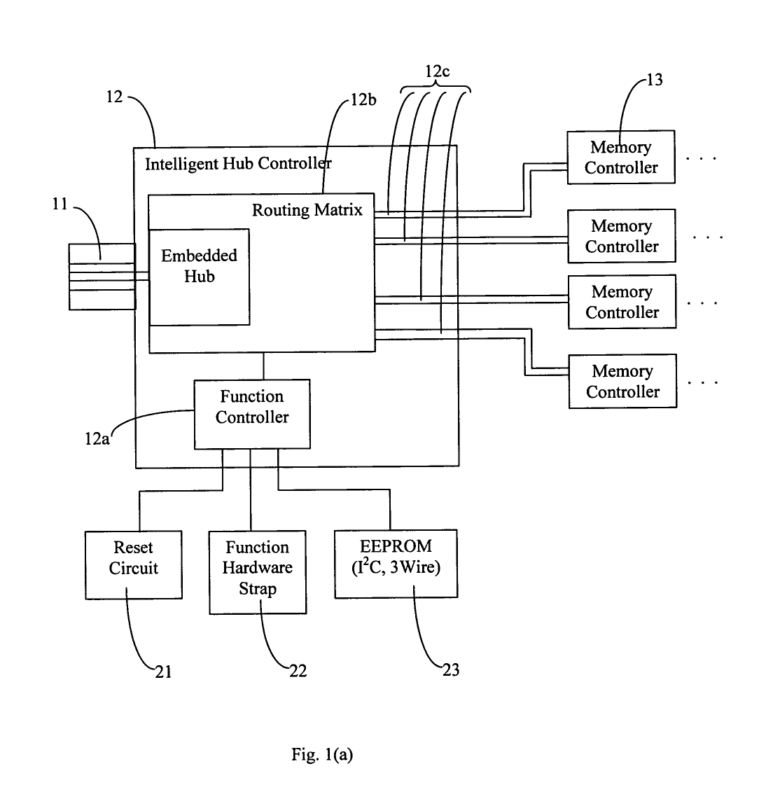

Another advantage of the USB or 1394 memory device configuration according to embodiments of the present invention is its flexibility and scalability. In one embodiment (e.g. as shown in FIG. 1), a commercially available hub controller 12 is used to connect to four memory controllers 13. In another embodiment, shown in FIG. 2 (for simplicity, other components of the memory devices are not shown), two commercially available USB or 1394 hub controllers 12-1 and 12-1 are employed, the first 12-1 having its upstream end connected to the USB or 1394 port 11, the second 12-2 having its upstream end connected to a downstream end of the first hub controller 12-1. Up to seven memory controllers 13 (only one is shown to avoid overcrowding) can be connected to the port 11 via the two hub controllers 12-1 and 12-2, increasing the capacity for the memory device. The memory banks may be programmed into one or more logical devices. For example, two of the four memory banks connected to the second hub controller 12-2 can be programmed as one logical device (corresponding to one drive letter, e.g. “E”) for striping (RAID0), and the other two of the four memory banks can be programmed as the mirror (RAID1) of the logical device “E”; and each of the three memory banks connected to the first hub can be programmed as one logical device. Of course, any other configuration can be used as desired. Similarly, five hub controllers each having four downstream ports may be employed to allow sixteen memory controllers to be connected to the USB or 1394 port 11. Other configurations are of course also possible.

Yet another advantage of the USB or 1394 memory device configuration according to embodiments of the present invention is its flexibility in sharing certain functions by all memory banks such as a “write protect switch”, therefore one write protect switch can be connected to all memory bank controller to achieve a simultaneously control on all memory banks. Further, the interconnection between the memory banks, memory controllers and the hub controller can be cross controlled and preprogrammed to sequence of enumeration, resetting, enabling, and disabling on each memory bank. These flexible design functions cannot be achieved by the conventional configuration using a hub with separated memory drives.

In addition, a USB or 1394 memory device shown in FIG. 1 can offer higher read/write speed than a conventional USB or 1394 memory device shown in FIG. 3. The read/write speed of a flash chip is typically about 50 Mbps, which is much slower than the speed of a USB port compatible with the USB 2.0 specification (480 Mbps), or a 1394 port compatible with the 1394A specification (400 Mbps), or a 1394B port compatible with the 1394B specification (800 Mbps). Thus, in a conventional USB or 1394 memory device 100 that includes one flash controller 103 (the controller can only access one flash chip at a time), the overall read/write speed of the memory device 100 is limited by the speed of the flash chips 104a. On the other hand, in a USB or 1394 memory device 10 shown in FIG. 1, the hub controller 12 may be programmed to communicate with multiple memory controllers 13 concurrently so that the multiple memory banks 14 are accessed concurrently. In one embodiment, RAID0 (non-redundant striped array) is implemented on the plurality of memory banks 14 where each memory bank 14 controlled by a memory controller 13 acts as an independent storage device in the array. By striping, data from one data file submitted by the host device are broken in to segments and stored on different memory banks 14 making up the array. The different memory banks 14 can be accessed concurrently to store the data segments. Thus, if the memory device 10 has four memory banks 14, the theoretical read/write speed of the memory device 10 is close to four times the speed of each flash chip, i.e., about 200 Mbps, still well below the speed of the USB 2.0 or 1394 port. In practice, due to various overhead, the actual speed of the memory device 10 will be slower than the theoretical speed, but the speed increase compared to conventional USB or 1394 memory devices (with one memory controlled and one bank of memory elements) is considerable. In one test, shown in Table I, read and write speeds were measured for a comparison device which was a standard 16 GB flash drive (one memory bank) and a test device (embodiment of the present invention) which included two memory banks each being a 16 GB flash drive (32 GB total) under striping. A USB 2.0 connection was used in the measurements of both devices. It can be seen from the test result that the overall speed rating result was 5.54:2.97=1.87:1, which means the test device (32 GB 2 banks with striping) is 87% faster. All measures were done on an Apple PowerMac3,4 PowerPC G4@734 MHz computer with the third party software called Xbench Version 1.2.

TABLE I

System Info

| | |
|---|---|
| Xbench Version | 1.2 |
| System Version | 10.3.9 (7W98) |
| Physical RAM | 1536 MB |

| | |
|---|---|
| Model | PowerMac3, 4 |

| | |
|---|---|
| Processor | PowerPC G4 @ 734 MHz |

| | |
|---|---|
| Version | 7450 (V′qer) v2.0 |
| L1 Cache | 32K (instruction), 32K (data) |
| L2 Cache | 256K @ 367 MHz |
| L3 Cache | 1024K @ 184 MHz |
| Bus Frequency | 134 MHz |

| | |
|---|---|
| Video Card | GeForce2 MX |

(Comparison)

| | |
|---|---|
| Drive Type | BUS USB 2.0 Flash Drive |

Disk Test 2.97

Sequential 3.33

| | |
|---|---|
| Uncached Write | 1.20 0.74 MB/sec [4K blocks] |
| Uncached Write | 11.40 6.45 MB/sec [256K blocks] |
| Uncached Read | 4.44 1.30 MB/sec [4K blocks] |
| Uncached Read | 19.09 9.59 MB/sec [256K blocks] |

| | |
|---|---|
| Random | 2.68 |

| | |
|---|---|
| Uncached Write | 0.73 0.08 MB/sec [4K blocks] |
| Uncached Write | 9.58 3.07 MB/sec [256K blocks] |
| Uncached Read | 176.04 1.25 MB/sec [4K blocks] |
| Uncached Read | 51.71 9.59 MB/sec [256K blocks] |

(Embodiment)

| | |
|---|---|
| Drive Type | BUS USB 2.0 Flash Drive with two memory |
| | banks |

Disk Test 5.54

| | |
|---|---|
| Sequential | 10.36 |

| | |
|---|---|
| Uncached Write | 15.59 9.57 MB/sec [4K blocks] |
| Uncached Write | 16.06 9.09 MB/sec [256K blocks] |
| Uncached Read | 4.44 1.30 MB/sec [4K blocks] |
| Uncached Read | 29.03 14.59 MB/sec [256K blocks] |

| | |
|---|---|
| Random | 3.78 |

| | |
|---|---|
| Uncached Write | 1.05 0.11 MB/sec [4K blocks] |
| Uncached Write | 11.43 3.66 MB/sec [256K blocks] |
| Uncached Read | 176.16 1.25 MB/sec [4K blocks] |
| Uncached Read | 78.29 14.53 MB/sec [256K blocks] |

As an alternative, other levels of RAID may be implemented in the memory device 10 (which has been programmed as a single logical device) where each memory bank 14 controlled by a memory controller 13 acts as an independent storage device in the RAID array. Implementing a RAID algorithm typically results in enhanced reliability, although introducing redundancy will reduce user data storage capacity for a given device. The implementation of a RAID algorithm is within the knowledge of those skilled in the relevant art and detailed descriptions are omitted here.

It should be noted that a RAID algorithm cannot be practically implemented in a system where a plurality of conventional USB or 1394 memory devices are connected to a host computer via a conventional stand-alone USB or 1394 hub device. This is because the logical relationship among the individual conventional USB or 1394 memory devices is not fixed. The USB or 1394 memories can be unplugged from the hub and re-plugged in, and it id difficult to guarantee that the relationship of the various memory devices remain unchanged.

As mentioned above, embodiments of the present invention utilize either commercially available IC components for the hub controller(s) 12, or custom-made intelligent hub controller(s) 12 with built-in multi-function (RAID and security), multi internal data path for optimizing the inter data flow. To minimize cost, one preferred embodiment utilizes commercially available IC components for the hub controller(s) 12, memory controllers 13 and memory elements 14a. The voltage regulator 16, oscillator 17, and other support circuits are also preferably commercially available components. These components may be packaged or unpackaged. Of course, custom designed components may be used for any of the above.

A USB or 1394 memory device according to embodiments of the present invention may be used on any computer platform that supports USB or 1394 devices.

It will be apparent to those skilled in the art that various modification and variations can be made in the USB or 1394 memory device of the present invention without departing from the spirit or scope of the invention. Thus, it is intended that the present invention cover modifications and variations that come within the scope of the appended claims and their equivalents.

What is claimed is:

1. A memory device comprising:
a communication port for connecting to an external communication port;
a first hub controller having an upstream end connected to the communication port;
a plurality of memory controllers each connected to a downstream end of the first hub controller; and
a plurality of memory banks each including a plurality of memory elements, each memory bank being connected to and controlled by a memory controller.

2. The memory device of claim 1, wherein the first hub controller, the plurality of memory controllers and the plurality of memory banks are enclosed in a casing.

3. The memory device of claim 2, wherein the communication port includes one or more power lines, the memory device further comprising a voltage regulator within the casing and having an input connected to the power lines of the communication port and an output for supplying a voltage to each memory element.

4. The memory device of claim 2, further comprising an oscillator circuit within the casing for providing a clock signal to the plurality of memory controllers.

5. The memory device of claim 2, further comprising an oscillator circuit within the casing for providing a clock signal to the first hub controller.

6. The memory device of claim 1, wherein the first hub controller, the plurality of memory controllers and the plurality of memory elements are capable of being powered by a current supplied from the communication port.

7. The memory device of claim 1, wherein the memory elements are flash chips, small form factor hard drives, or combinations thereof.

8. The memory device of claim 1, wherein the memory elements includes a combination of non-volatile memory elements and volatile memory elements.

9. The memory device of claim 1, wherein the communication port has at least one pair of differential data lines.

10. The memory device of claim 1, wherein the communication port is a universal serial bus (USB) communication port.

11. The memory device of claim 1, wherein the communication port is a 1394 (Firewire) communication port.

12. The memory device of claim 1, wherein the first hub controller is implemented on an IC chip.

13. The memory device of claim 1, wherein the first hub controller and one of the plurality of memory controllers are implemented on an IC chip.

14. The memory device of claim 1, wherein the first hub controller and the plurality of memory controllers are implemented on an IC chip.

15. The memory device of claim 1, wherein the first hub controller controls the communication between a host device connected to the communication port and the plurality of memory controllers.

16. The memory device of claim 1, wherein the first hub controller and the plurality of memory controllers are programmed so that each memory bank controlled by a memory controller is a logical device.

17. The memory device of claim 1, wherein the first hub controller and the plurality of memory controllers are programmed so that the memory device is a logical device.

18. The memory device of claim 1, wherein the first hub controller and the plurality of memory controllers are programmed so that a subset of the memory banks is a logical device.

19. The memory device of claim 1, wherein the first hub controller and the plurality of memory controllers are programmed to implement striping on a subset or all of the plurality of memory banks.

20. The memory device of claim 1, wherein the first hub controller and the plurality of memory controllers are programmed to implement a RAID algorithm on a subset or all of the plurality of memory banks.

21. The memory device of claim 1, wherein four memory controllers are connected to the first hub controller.

22. The memory device of claim 1, further comprising a second hub controller having an upstream end connected to a downstream end of the first hub controller, and a plurality of memory controllers each connected to a downstream end of the second hub controller.

23. A hub controller for connecting a set of upstream communication lines to a plurality of sets of downstream communication lines each for connecting to a memory controller, the hub controller comprising:
a routing matrix connected to the set of upstream communication lines and the plurality of sets of downstream communication lines, the routing matrix having a plurality of data paths connecting the set of upstream communication lines to the plurality of sets of downstream communication lines and connecting the sets of downstream communication lines to each other; and
a functional controller for controlling the routing of data between the communication lines by the routing matrix.

24. The hub controller of claim 23, wherein the function controller is programmable by a program downloaded from a host computer connected to the set of upstream communication lines, a program stored in an external memory connected to the function controller, or a function hardware strap connected to the function controller.

25. The hub controller of claim 23, wherein the function controller detects a configuration of the memory controllers connected to the downstream communication lines.
